(19) United States
(12) Patent Application Publication
(10) Pub. No.: US 2017/0188261 A1
(43) Pub. Date: Jun. 29, 2017

(54) USER EQUIPMENT, COLLISION REPORTING METHOD, BASE STATION, AND RESOURCE ALLOCATION METHOD

(71) Applicant: NTT DOCOMO, INC., Tokyo (JP)

(72) Inventors: Hiroki Harada, Tokyo (JP); Shimpei Yasukawa, Tokyo (JP); Satoshi Nagata, Tokyo (JP); Qun Zhao, Beijing (CN); Yongbo Zeng, Beijing (CN); Yongsheng Zhang, Beijing (CN)

(73) Assignee: NTT DOCOMO, INC., Tokyo (JP)

(21) Appl. No.: 15/308,789

(22) PCT Filed: Apr. 9, 2015
(86) PCT No.: PCT/JP2015/061101

§ 371 Date: Nov. 3, 2016

(30) Foreign Application Priority Data
May 8, 2014 (JP) 2014-097195

(51) Int. Cl. H04W 28/04; H04W 8/00; H04W 72/12; H04L 12/26

(52) U.S. Cl. CPC H04W 28/044; H04L 43/065; H04W 8/005; H04W 28/046; H04W 72/1263

(57) ABSTRACT

User equipment for receiving a discovery signal to be used for inter-user equipment discovery includes a discovery signal receiver that receives the discovery signal transmitted, within a resource pool for transmitting the discovery signal, from any other user equipment; a collision detector that detects collision of discovery signals; and a reporting unit that reports a detected result of the collision to a base station.

### TECHNICAL FIELD

The present invention relates to user equipment, a collision reporting method, a base station, and a resource allocation method.

### BACKGROUND ART

As for the mobile communication, it is common that terminals (which are referred to as user equipment UEs, hereinafter) communicate with a base station eNB, so as to perform inter-user equipment UE communication; however, in recent years, various types of technology have been studied for performing direct inter-user equipment UE communication (cf. Non-Patent Document 1). It is referred to as D2D (Device to Device) communication to perform direct inter-user equipment UE communication.

As an application for the inter-user equipment UE communication, one user equipment UE may discover any other user equipment UE in the vicinity (D2D discovery). As a method of discovering the user equipment UE, there is a method in which each user equipment UE transmits (broadcasts) a discovery signal (discovery signal) including its own ID.

FIG. 1 is a diagram illustrating resources for transmitting discovery signals. In the example of FIG. 1, it is defined so that, discovery periods (discovery period) periodically occur, which are for discovering (or being discovered as) user equipment UE by transmitting and receiving discovery signals; and, for each discovery period, resources (time-frequency resources) 1-40 are defined, which are for transmitting (and receiving) the discovery signals. A set of the time-frequency resources 1-40 in one discovery period is referred to as a resource pool.

During a discovery period, each user equipment UE transmits a discovery signal by using a resource in the resource pool. The resource for transmitting the discovery signal and a resource for cellular communication (which is referred to as the WAN, hereinafter) are multiplexed. Multiplexing is performed as frequency division multiplexing (FDM: Frequency Division Multiplexing), time division multiplexing (TDM: Time Division Multiplexing), or a combination of the TDM and the FDM, for example.

For a resource to be used by each user equipment UE in the resource pool, there are a case where it is autonomously determined by the user equipment UE itself; and a case where it is determined in accordance with scheduling by the base station eNB. The resource allocation method in which the base station eNB semi-statically allocates a resource is referred to as a type 2B discovery procedure (Type 2B discovery). In the type 2B discovery procedure, for user equipment UE that supports half-duplexing (half duplex) where transmission and reception of discovery signals at the same timing are not allowed, hopping on resources is performed. For example, in the example of FIG. 1, the resource 22 is allocated for transmitting a discovery signal from UE A; the resource 17 is allocated for transmitting a discovery signal from UE B; and the resource 23 is allocated for transmitting a discovery signal from UE C. For a case where user equipment UE A-UE C are not allowed to transmit and receive the discovery signals at the same timing, the user equipment UE A-UE C may not mutually discover any other user equipment at the timing of (a) of FIG. 1. However, when positions of the resources are changed at each of the discovery periods due to hopping on the resources, at the timing (b) of FIG. 1, the user equipment UE C is allowed to receive discovery signals from the user equipment UE A and UE B. Furthermore, at the timing (c) of FIG. 1, each of the user equipment UE A-UE C is allowed to receive a discovery signal from any other user equipment.

### PRIOR ART DOCUMENT

### Non-Patent Document

Non-Patent Document 1: 3GPP TR 36.843 V12.0.1 (2014-03)

### SUMMARY OF INVENTION

### Problem to be Solved by the Invention

By the type 2B discovery procedure, such as that of illustrated in FIG. 1, collision between discovery signals transmitted from user equipment UEs in the same cell can be avoided. Furthermore, by the hopping on the resources, even if the user equipment UE is for half duplexing, the user equipment UE can detect a discovery signal of any other user equipment.

However, there is still a possibility that collision of discovery signals occurs between cells. For example, in order to cause discovery signals to be able to be detected between cells, resource pools with the same time-frequency resources may be used. Furthermore, for a case where a common resource hopping pattern is used between cells, even if hopping on the resources is performed for each discovery period, there is a possibility that collision of the discovery signals is continued.

FIG. 2 is a diagram illustrating the collision of the discovery signals between the cells. The base station eNB 1 allocates a resource for a discovery signal to user equipment UE A in its own cell; and the base station eNB 2 allocates a resource for a discovery signal to user equipment UE B in its own cell. For a case where the same resource 3 is allocated to the user equipment UE A and the user equipment UE B, discovery signals collide at this resource 3, and each of the user equipment is mutually unable to detect the discovery signals at the timing (a) of FIG. 2. Furthermore, for a case where a common resource hopping pattern is used between the cells, the resource 3 that is allocated to the user equipment UE A and UE B hops to the same time-frequency resources at the timings of (b) and (c) of FIG. 2, respectively, so that they are mutually unable to discover the user equipment.

An object of the present invention is to reduce or avoid the collision of the discovery signals between the cells, for a case where user devices transmit discovery signals with resources allocated by a base station in the D2D communication.

### Means for Solving the Problem

User equipment according to an aspect of the present invention is for receiving a discovery signal to be used for inter-user equipment discovery, the user equipment including a discovery signal receiver that receives the discovery signal transmitted, within a resource pool for transmitting the discovery signal, from any other user equipment; a collision detector that detects collision of discovery signals; and a reporting unit that reports a detected result of the collision to a base station.

Further, a collision reporting method according to an aspect of the present invention is for use in user equipment for receiving a discovery signal to be used for inter-user equipment discovery, the collision reporting method including a step of receiving the discovery signal transmitted, within a resource pool for transmitting the discovery signal, from any other user equipment; a step of detecting collision of discovery signals; and a step of reporting a detected result of the collision to a base station.

Further, a base station according to an aspect of the present invention is for allocating, to user equipment, a resource for a discovery signal to be used for inter-user equipment discovery, the base station including a scheduler that allocates, within a resource pool for transmitting the discovery signal, the resource for the discovery signal to the user equipment; and a resource reporting unit that reports the allocated resource to the user equipment, wherein the scheduler re-allocates, based on a result of collision reported from the user equipment, or periodically, a resource for the discovery signal.

Further, a resource allocation method according to an aspect of the present invention is for use in a base station for allocating, to user equipment, a resource for a discovery signal to be used for inter-user equipment discovery, the resource allocation method including a step of allocating, within a resource pool for transmitting the discovery signal, the resource for the discovery signal to the user equipment; a step of reporting the allocated resource to the user equipment; and a step of re-allocating, based on a result of collision reported from the user equipment, or periodically, a resource for the discovery signal.

Further, a base station according to an aspect of the present invention is for allocating, to user equipment, a resource for a discovery signal to be used for inter-user equipment discovery, the base station including a scheduler that allocates, within a predetermined resource group of resource groups formed by dividing a resource pool for transmitting the discovery signal, the resource for the discovery signal to the user equipment; and a resource reporting unit that reports the allocated resource to the user equipment.

Furthermore, a resource allocation method according to an aspect of the present invention is for use in a base station for allocating, to user equipment, a resource for a discovery signal to be used for inter-user equipment discovery, the resource allocation method including a step of allocating, within a predetermined resource group of resource groups formed by dividing a resource pool for transmitting the discovery signal, the resource for the discovery signal to the user equipment; and a step of reporting the allocated resource to the user equipment.

### Advantage of the Invention

According to the present invention, for a case where user equipment transmits a discovery signal with a resource allocated by a base station in the D2D communication, collision of the discovery signals between cells can be reduced or avoided.

### BRIEF DESCRIPTION OF DRAWINGS

FIG. 1 is a diagram illustrating a resource for transmitting a discovery signal;

FIG. 2 is a diagram illustrating collision of the discovery signals between cells;

FIG. 3 is a schematic diagram of a communication system according to an embodiment of the present invention;

FIG. 4 is a configuration diagram of a base station according to first to fourth examples of the present invention;

FIG. 5 is a flowchart illustrating a method of avoiding the collision of the discovery signals in the base station according to the first example of the present invention;

FIG. 6 is a configuration diagram of user equipment according to the second example of the present invention;

FIG. 7 is a sequence diagram illustrating the method of avoiding the collision of the discovery signals in the user equipment and the base station according to the second example of the present invention;

FIG. 8 is a flowchart illustrating a method of reporting the collision of the discovery signals in the user equipment according to the second example of the present invention;

FIG. 9 is a schematic diagram illustrating the method of avoiding the collision of the discovery signals according to the third example of the present invention;

FIG. 10 is a configuration diagram of the user equipment according to the third example of the present invention;

FIG. 11 is a sequence diagram illustrating the method of avoiding the collision of the discovery signals in the user equipment and the base station according to the third example of the present invention;

FIG. 12 is a flowchart illustrating the method of reporting the collision of the discovery signals in the user equipment according to the third example of the present invention;

FIG. 13 is an example illustrating a resource for suppressing transmission of the discovery signal (version 1);

FIG. 14 is an example illustrating the resource for suppressing transmission of the discovery signal (version 2);

FIG. 15 is a sequence diagram illustrating the method of avoiding the collision of the discovery signals in the user equipment and the base station according to a modified example of the present invention (version 1);

FIG. 16 is a sequence diagram illustrating the method of avoiding the collision of the discovery signals in the user equipment and the base station according to the modified example of the present invention (version 2);

FIG. 17 is a schematic diagram illustrating the method of avoiding the collision of the discovery signals according to the fourth example of the present invention (version 1); and

FIG. 18 is a schematic diagram illustrating the method of avoiding the collision of the discovery signals according to the fourth example of the present invention (version 2).

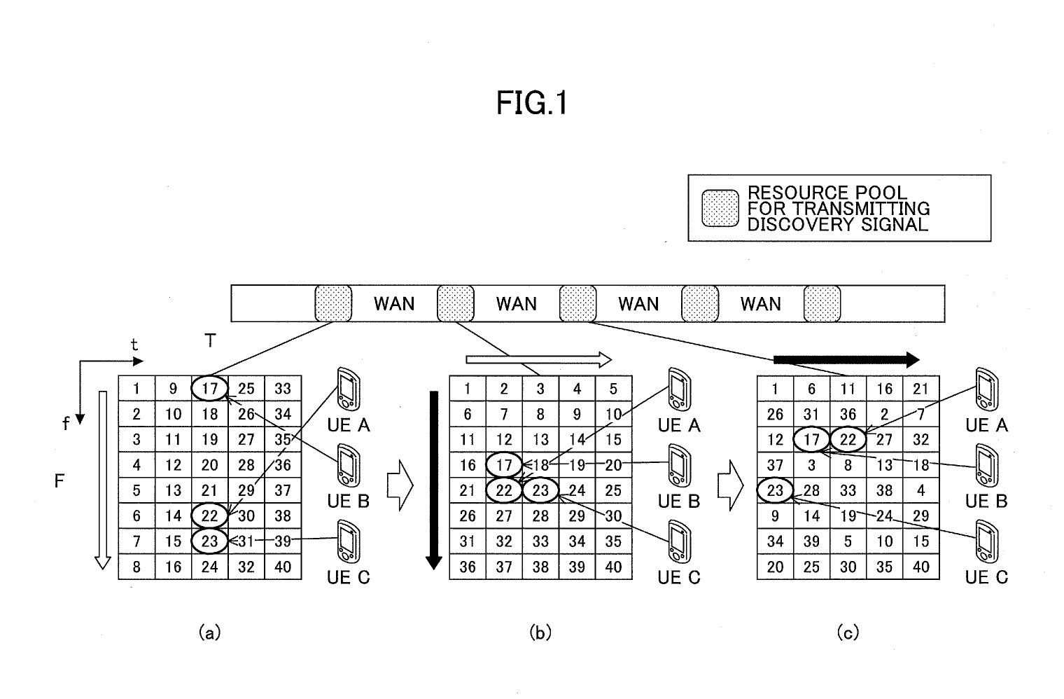

### EMBODIMENTS OF THE INVENTION

An embodiment of the present invention is described below based on the drawings.

<Outline of the Communication System>

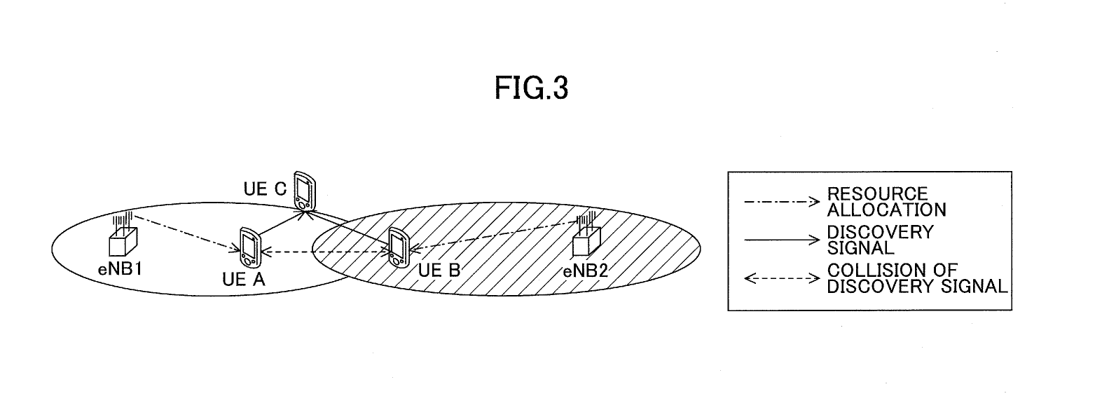

FIG. 3 is a schematic diagram of a communication system according to the embodiment of the present invention. The communication system according to the embodiment of the present invention is a cellular communication system where a plurality of user equipment UEs exist under control of a base station eNB. In the communication system, there are a plurality of base stations eNBs and the plurality of user equipment UEs; however, in FIG. 3, two base stations eNB 1 and eNB 2, and three user equipment UE A-UE C are illustrated, among them.

For a discovery signal, the base stations eNB 1 and eNB 2 use resource pools, respectively, which are the same time-frequency resources. The base station eNB 1 allocates, to the user equipment UE A in its own cell, a resource for the discovery signal in the resource pool; and the base station eNB 2 allocates, to the user equipment UE B in its own cell, a resource for the discovery signal in the resource pool. The user equipment UE A-UE C transmit discovery signals by using the allocated resources. Further, each of the user equipment UE A-UE C receives a discovery signal transmitted from any other user equipment in the resource pool for transmitting (and receiving) the discovery signals.

For a case where the resource allocated to the user equipment UE A by the base station eNB 1 and the resource allocated to the user equipment UE B by the base station eNB 2 are the same time-frequency resource, collision of the discovery signals occurs. In this case, the user equipment UE A and the user equipment UE B are unable to detect each other; and the user equipment UE C is also unable to discover the user equipment UE A and UE B. Furthermore, for a case where a resource hopping pattern that is common between the cells is to be used, the collision of the discovery signals continues.

In order to avoid such collision of the discovery signals between cells, it is necessary for the base stations eNB 1 and eNB 2 to re-allocate resources for the discovery signals. In the embodiment of the present invention, the following methods of reducing or avoiding the collision of the discovery signals are described, respectively.

(1) A base station re-schedules, based on a result of collision reported from user equipment, or periodically, a resource for a discovery signal.

More specifically, the following method may be used.

### First Example

The base station periodically re-schedules a resource for a discovery signal. In this case, a report of a result of collision from user equipment may not be used.

### Second Example

User equipment that detects collision of discovery signals reports, to a base station, a time-frequency position of the resource where the collision occurs; and the base station re-allocates a resource to the user equipment for which the collision occurs.

### Third Example

User equipment to which a resource for transmitting a discovery signal is allocated suppresses (mutes) transmission of the discovery signal in a part of discovery periods, and detects a discovery signal from any other user equipment in the resource that was originally scheduled to be transmitted. For a case where a discovery signal of any other user equipment is detected, the user equipment reports the result of the collision (a re-scheduling request for a resource) to the base station; and the base station re-allocates a resource to the user equipment.

### Modified Example

Note that, in order to avoid collision of discovery signals from the beginning, the base station may schedule a resource of the discovery signal, based on a measurement result from user equipment.

(2) A resource pool for transmitting (and receiving) discovery signals is divided into a plurality of resource groups; and a resource for a discovery signal is allocated within a resource group.

### Fourth Example

A resource pool for transmitting (and receiving) discovery signals is divided into a plurality of resource groups (or subsets). A base station schedules a resource for a discovery signal in a specific resource group. Note that, for a case where hopping on resources is to be performed, it is limited to within the specific resource group. In order to enhance utilization efficiency of resources, for user equipment at a center of a cell, a resource may be allocated within the whole resource pool; and for user equipment at a cell edge, a resource may be allocated within the resource group.

These methods are described below in detail.

### First Example

In the first example of the present invention, a case is described where a base station periodically re-schedules a resource for a discovery signal.

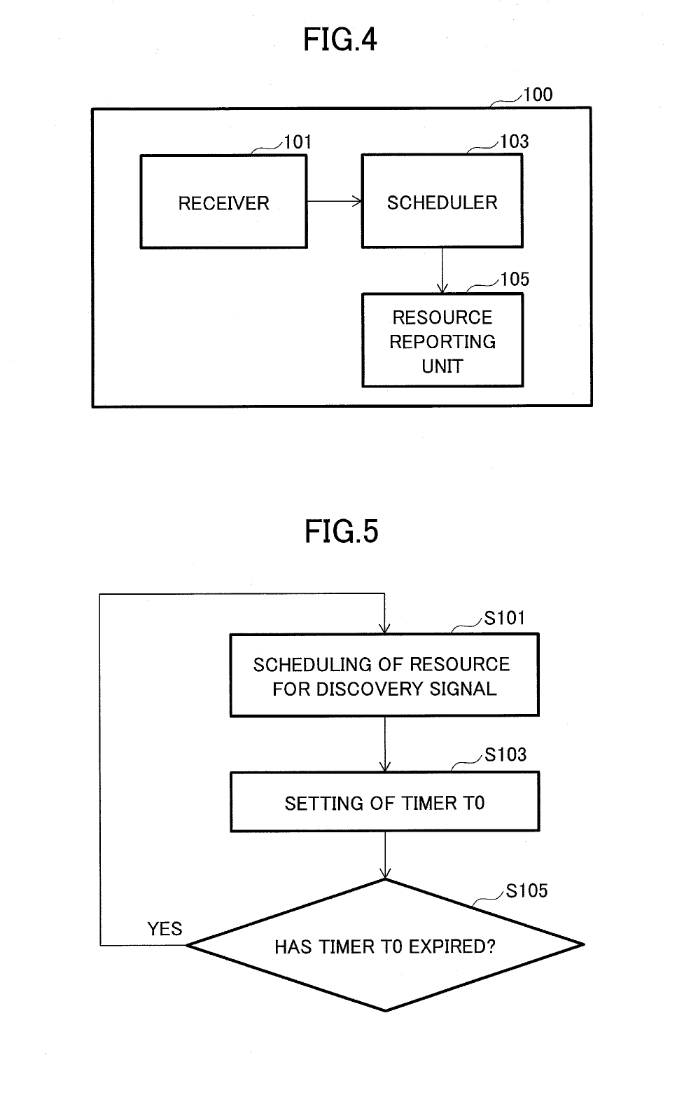

FIG. 4 is a configuration diagram of a base station according to the first example of the present invention. The base station 100 includes a receiver 101: a scheduler 103: and a resource reporting unit 105.

The receiver 101 receives a result of collision of discovery signals, which is detected by user equipment. The result of the collision includes a position of a time-frequency resource at which the collision occurs; and a frame number or a subframe number at which the collision occurs (as to which discovery period, the collision occurs). Note that, in the first example of the present invention, the base station periodically re-schedules the resource for the discovery signal, so that the report of the result of collision from the user equipment may not be used.

The scheduler 103 allocates a resource for a discovery signal to user equipment within a resource pool for transmitting the discovery signal. In the first example of the present invention, the scheduler 103 periodically re-schedules the resource for the discovery signal by using, for example, a timer. During re-scheduling, all resources within the resource pool may be re-allocated at once; or resources may be individually re-allocated based on an individual timer of each user equipment. Consequently, even for user equipment for which no collision occurs, a resource is re-allocated.

The resource reporting unit 105 reports allocated resources to user equipment.

FIG. 5 is a flowchart illustrating the method of avoiding collision of discovery signals in the base station according to the first example of the present invention.

The scheduler 103 of the base station 100 schedules a resource for a discovery signal within a resource pool for transmitting the discovery signal (step S101). The resource allocated by scheduling is reported from the resource reporting unit 105 to the user equipment.

At this time, the scheduler 103 establishes a timer TO that is to expire at a predetermined time (step S103). Upon expiration of the timer TO, the scheduler 103 re-schedules a resource for the discovery signal (step S105).

In this manner, by periodically re-scheduling, by a base station, a resource for the discovery signal, collision of discovery signals can be reduced.

### Second Example

In the second example of the present invention, a case is described where user equipment that detects collision of discovery signals reports, to a base station, a time-frequency position of a resource at which the collision occurs; and the base station re-allocates a resource to the user equipment for which the collision occurs.

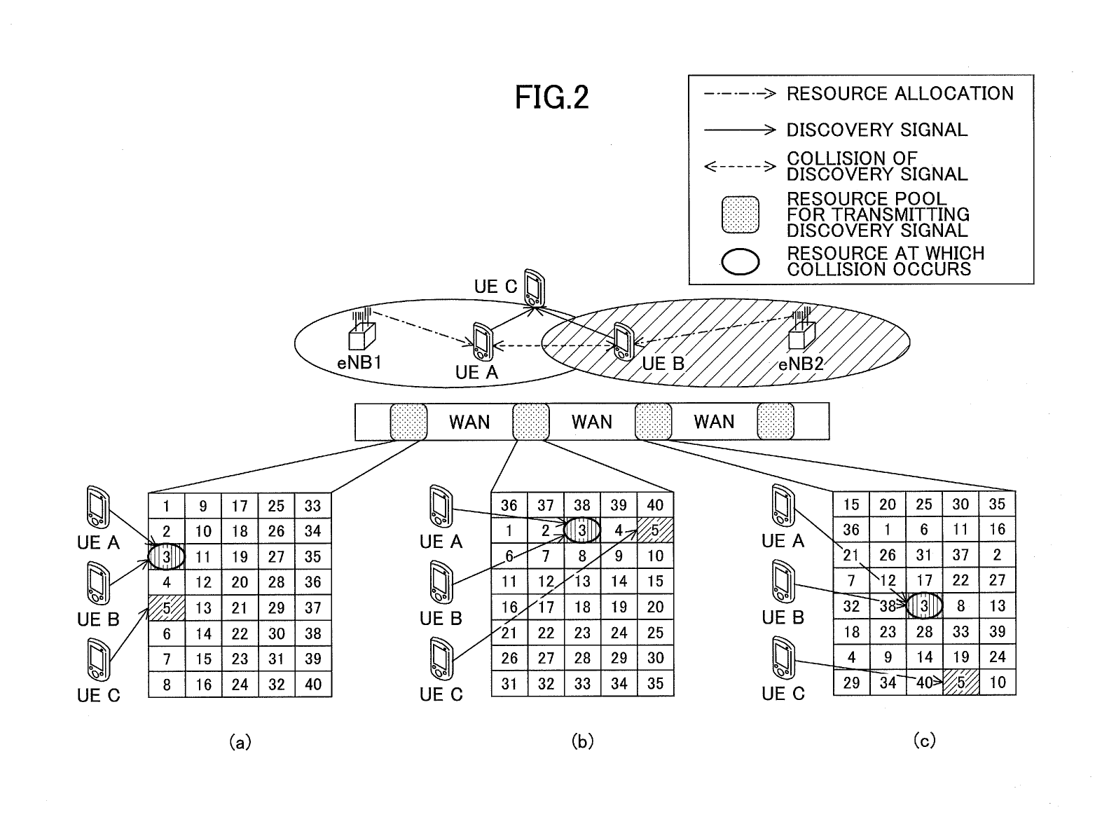

As illustrated in FIG. 2, when the resource that is allocated to the user equipment UE A by the base station eNB 1 and the resource that is allocated to the user equipment UE B by the base station eNB 2 are the same time-frequency resource, collision of the discovery signals occurs. In this case, the user equipment UE C is able to detect that the discovery signal transmitted from the user equipment UE A collides with the discovery signal transmitted from the user equipment UE B. By reporting, by the user equipment UE C, the result of the collision to the base station, the base station is able to re-allocate resources for the user equipment.

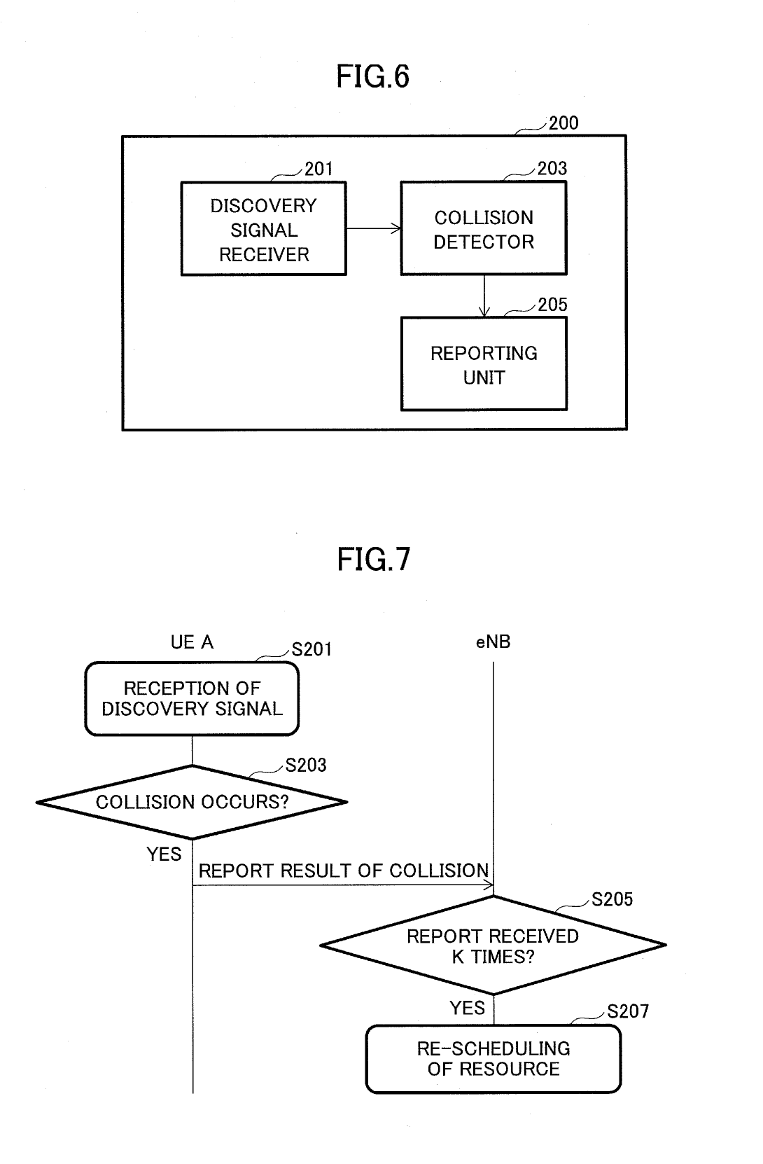

FIG. 6 is a configuration diagram of the user equipment according to the second example of the present invention. The user equipment 200 includes a discovery signal receiver 201; a collision detector 203; and a reporting unit 205. The user equipment 200 may be user equipment (the UE C of FIG. 3) to which no resource for a discovery signal is allocated, or may be user equipment to which a resource for a discovery signal is allocated. For a case where a resource for a discovery signal is allocated to the user equipment 200, the user equipment 200 detects collision at a resource other than the allocated resource. Additionally, the user equipment 200 that reports the result of the collision may be user equipment in a connected state (RRC_Connected).

The discovery signal receiver 201 receives, within a resource pool for transmitting a discovery signal, a discovery signal transmitted from any other user equipment.

The collision detector 203 detects collision of discovery signals. For example, when reception of a discovery signal fails at a specific resource (e.g., cyclic redundancy checking (CRC: Cyclic Redundancy Check) fails), and when received energy at the resource is greater than a threshold value, it can be considered that a plurality of user equipment simultaneously transmits discovery signals with the resource. In this case, the collision detector 203 may determine that the discovery signals collide.

The reporting unit 205 reports a detected result of the collision. The result of the collision includes a position of the time-frequency resource at which the collision occurs; and a frame number or a subframe number at which the collision occurs (as to which discovery period, the collision occurs). The result of the collision may be reported through uplink RRC (Radio Resource Control) signaling; a physical uplink control channel (PUCCH: Physical Uplink Control Channel); a physical uplink shared channel (PUSCH: Physical Uplink Shared Channel), and so forth. The RRC signaling, the PUCCH, and the PUSCH may be those defined for the existing communication system, or may be those newly defined.

The base station according to the second example of the present invention is configured to be the same as that of FIG. 4.

The receiver 101 receives a result of collision of discovery signals, which is detected by the user equipment 200. In the second example of the present invention, the result of the collision is received from the user equipment 200 that detects the collision of the discovery signals. From the position of the time-frequency resource and the frame number or the subframe number, the user equipment can be found for which the collision occurs.

The scheduler 103 allocates, within a resource pool for transmitting a discovery signal, a resource for the discovery signal to the user equipment. In the second example of the present invention, the scheduler 103 re-allocates a resource to the user equipment for which the collision occurs. In order to enhance reliability, upon being reported a predetermined number (K) of the results of collision for the same resource, the scheduler 103 may re-allocate a resource for the discovery signal.

The resource reporting unit 105 reports the allocated resource to the user equipment.

FIG. 7 is a sequence diagram illustrating a method of avoiding collision of discovery signals in the user equipment and the base station according to the second example of the present invention.

A discovery signal receiver 201 of the user equipment 200 receives a discovery signal transmitted from any other user equipment (step S201). A collision detector 203 determines whether discovery signals collide or not (step S203). When the discovery signals collide, the reporting unit 205 reports, to the base station, a result of collision including a position of the time-frequency resource at which the collision occurs, and a frame number or a subframe number at which the collision occurs.

The receiver 101 of the base station 100 receives the result of the collision of the discovery signals; and the scheduler 103 determines whether K results of the collision are reported for the same resource (step S205). Upon the K results of the collision being reported for the same resource, the scheduler 103 re-allocates a resource to the user equipment for which the collision occurs (step S207).

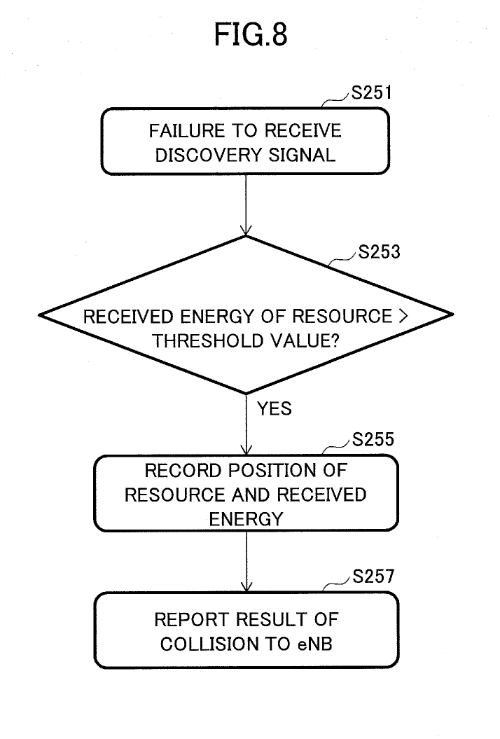

The detection of the collision of the discovery signals at step S203 of FIG. 7 is further described by referring to FIG. 8. FIG. 8 is a flowchart illustrating a method of reporting the collision of the discovery signals in the user equipment according to the second example of the present invention.

The collision detector 203 of the user equipment 200 attempts to receive, with the CRC, for example, the discovery signal received by the discovery signal receiver 201. When reception of the discovery signal fails at a specific resource (step S251), the collision detector 203 determines whether the received energy of the resource is greater than a threshold value (step S253). When the received energy is less than the threshold value, no discovery signal is transmitted, so that the collision detector 203 determines that no collision has occurred. In contrast, when the received energy is greater than the threshold value, a plurality of user equipment simultaneously transmits discovery signals with the resource, so that a determination is made that collision has occurred.

In this case, the collision detector 203 records the position of the resource (the position of the time-frequency resource, and the frame number or the subframe number); and the received energy (step S255).

The reporting unit 205 reports, to the base station, the result of the collision including the resource position and the received energy (step S257). In order to avoid that collision occurs in a discovery period subsequent to the discovery period in which the collision has occurred, the reporting unit 205 may report the result of the collision to the base station, prior to the subsequent discovery period.

In this manner, by re-allocating, by the base station, a resource for the discovery signal based on the result of the collision reported from the user equipment, collision of discovery signals can be avoided.

### Third Example

In the third example of the present invention, a case is described where user equipment, to which a resource for transmitting a discovery signal is allocated, and which detects collision of discovery signals by suppressing (muting) transmission of the discovery signal in a part of a discovery period, and by detecting a discovery signal from any other user equipment in the resource that is originally scheduled for executing transmission, requests a base station to re-allocate a resource; and the base station re-allocates a resource for the user equipment for which the collision has occurred.

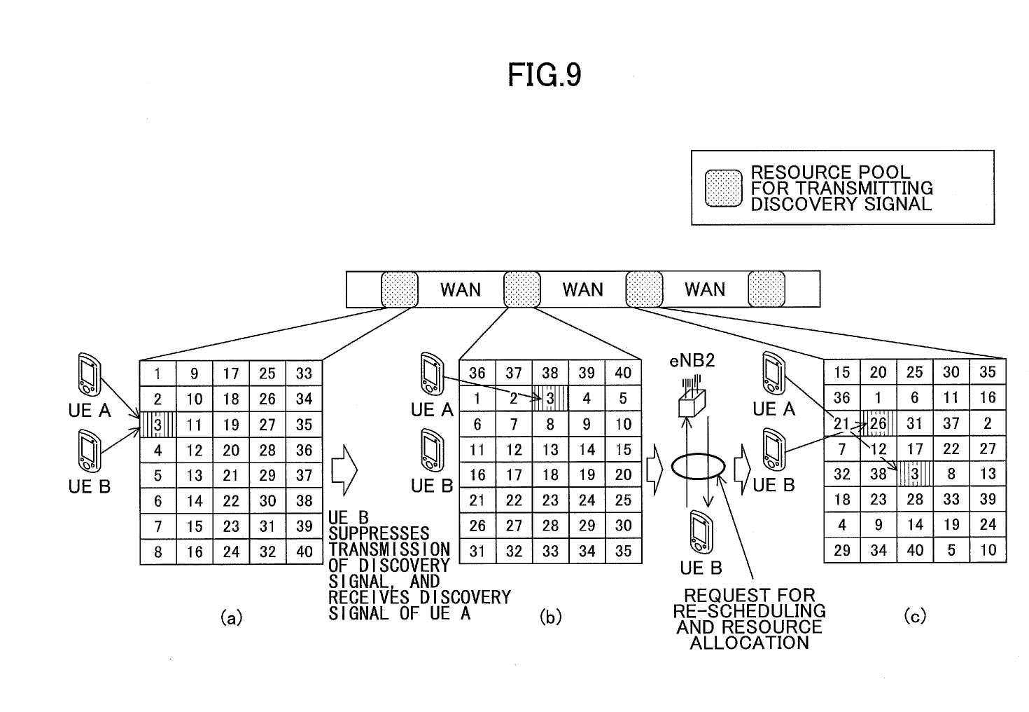

FIG. 9 is a schematic diagram illustrating the method of avoiding the collision of the discovery signals according to the third example of the present invention. As illustrated in FIG. 9, when a resource allocated to the user equipment UE A by the base station eNB 1 and a resource allocated to the user equipment UE B by the base station eNB 2 are the same time-frequency resource, collision of discovery signals occurs. The user equipment UE B mutes transmission of a discovery signal in a specific discovery period, and receives a discovery signal from the other user equipment UE A transmitted with the resource that is originally scheduled for executing transmission. When the discovery signal from the other user equipment is received, the user equipment UE B is able to detect that there is a possibility that collision of the discovery signals occurs. The user equipment UE B transmits a re-scheduling request for switching a resource for the discovery signal to the eNB 2; and, consequently, the base station eNB 2 can re-allocate a resource for the user equipment UE B.

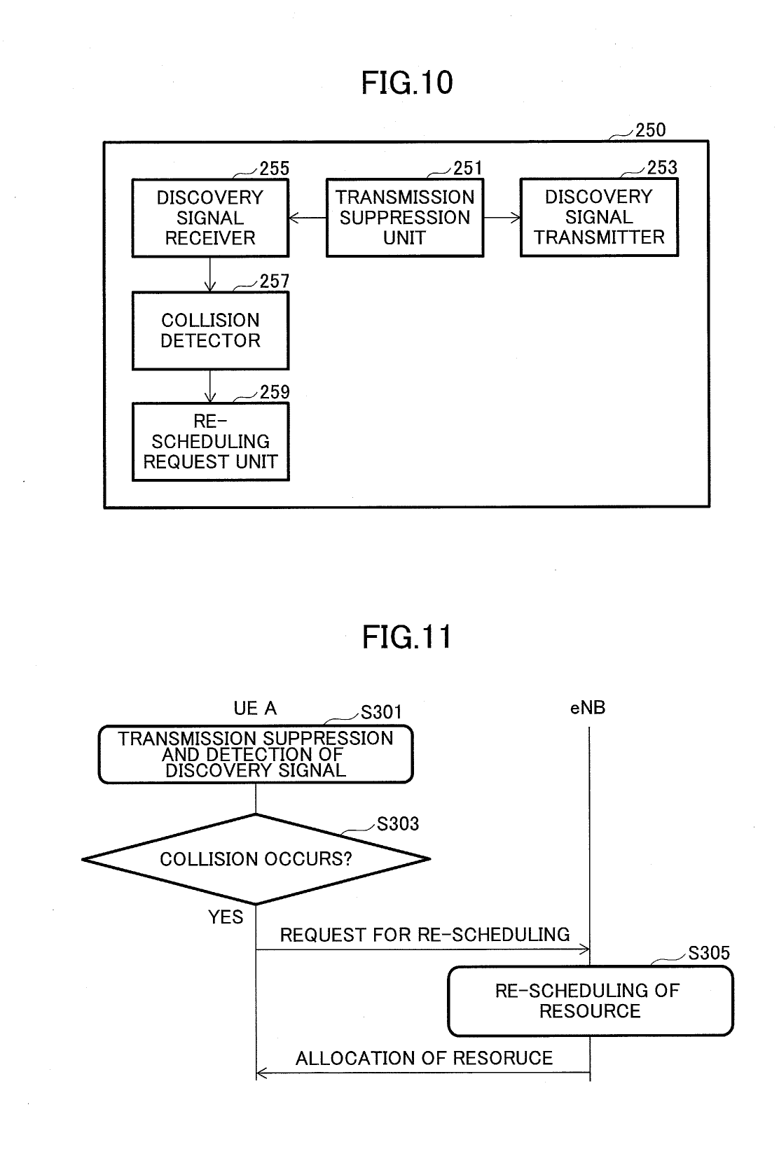

FIG. 10 is a configuration diagram of the user equipment according to the third example of the present invention. The user equipment 250 includes a transmission suppression unit 251; a discovery signal transmitter 253; a discovery signal receiver 255; a collision detector 257; and a re-scheduling request unit 259. The user equipment 250 is the user equipment (the UE A or the UE B of FIG. 3) to which the resource for the discovery signal is allocated.

The transmission suppression unit 251 mutes transmission of a discovery signal at a part of a resource allocated by the base station. The resource for transmitting the discovery signal is semi-statically allocated by the base station, so that a resource can be reserved for each discovery period. The transmission suppression unit 251 mutes transmission of a discovery signal in a part of a discovery period. Furthermore, the transmission suppression unit 251 causes the discovery signal receiver 255 to receive a discovery signal from any other user equipment through the resource for which transmission of the discovery signal is muted.

The discovery signal transmitter 253 transmits a discovery signal by using a resource allocated by the base station. However, when transmission of a discovery signal is muted by the transmission suppression unit 251, the discovery signal transmitter 253 does not transmit the discovery signal.

The discovery signal receiver 255 receives a discovery signal transmitted from any other user equipment within a resource pool for transmitting the discovery signal. Additionally, in the resource for which transmission of a discovery signal is muted by the transmission suppression unit 251, the discovery signal receiver 255 receives a discovery signal from any other user equipment.

The collision detector 257 detects that there is a possibility that collision of discovery signals occurs. For a case where a discovery signal from any other user equipment is received at a resource for which transmission of a discovery signal is muted by the transmission suppression unit 251, the collision detector 257 is able to detect that there is a possibility that collision of discovery signals occurs.

The re-scheduling request unit 259 corresponds to the reporting unit 205 of the user equipment 200 illustrated in FIG. 5. The re-scheduling request unit 259 reports a detected result of the collision to the base station. In the third example of the present invention, it is not necessary to report, to the base station, a position of the time-frequency resource, a frame number or a subframe number, and so forth; and the re-scheduling request unit 259 transmits, to the base station, a re-scheduling request for requesting re-scheduling of a resource for the discovery signal, based on the detected result of the collision.

The base station according to the third example of the present invention is configured to be the same as that of FIG. 4.

The receiver 101 receives the result of the collision of the discovery signals detected by the user equipment; and, in this example, the receiver 101 receives the re-scheduling request. Based on the sender of the re-scheduling request, the user equipment with a possibility of collision can be found.

The scheduler 103 allocates, within a resource pool for transmitting a discovery signal, a resource for the discovery signal to user equipment. In the third example, the scheduler 103 re-allocates a resource to the user equipment from which the re-scheduling request is received.

The resource reporting unit 105 reports the allocated resource to the user equipment.

FIG. 11 is a sequence diagram illustrating the method of avoiding the collision between the discovery signals in the user equipment and the base station according to the third example of the present invention.

The transmission suppression unit 251 of the user equipment 250 mutes transmission of a discovery signal in a part of a resource allocated by the base station. Then, the discovery signal receiver 255 is caused to receive a discovery signal from any other user equipment through the resource for which transmission of the discovery signal is muted (step S301). When a discovery signal from any other user equipment is received through the resource for which transmission of the discovery signal is muted by the transmission suppression unit 251, the collision detector 257 detects collision of discovery signals (step S303). When the collision is detected, the re-scheduling request unit 259 transmits a re-scheduling request to the base station.

The receiver 101 of the base station 100 receives the re-scheduling request; and the scheduler 103 re-allocates a resource to the user equipment from which the re-scheduling request is received (step S305).

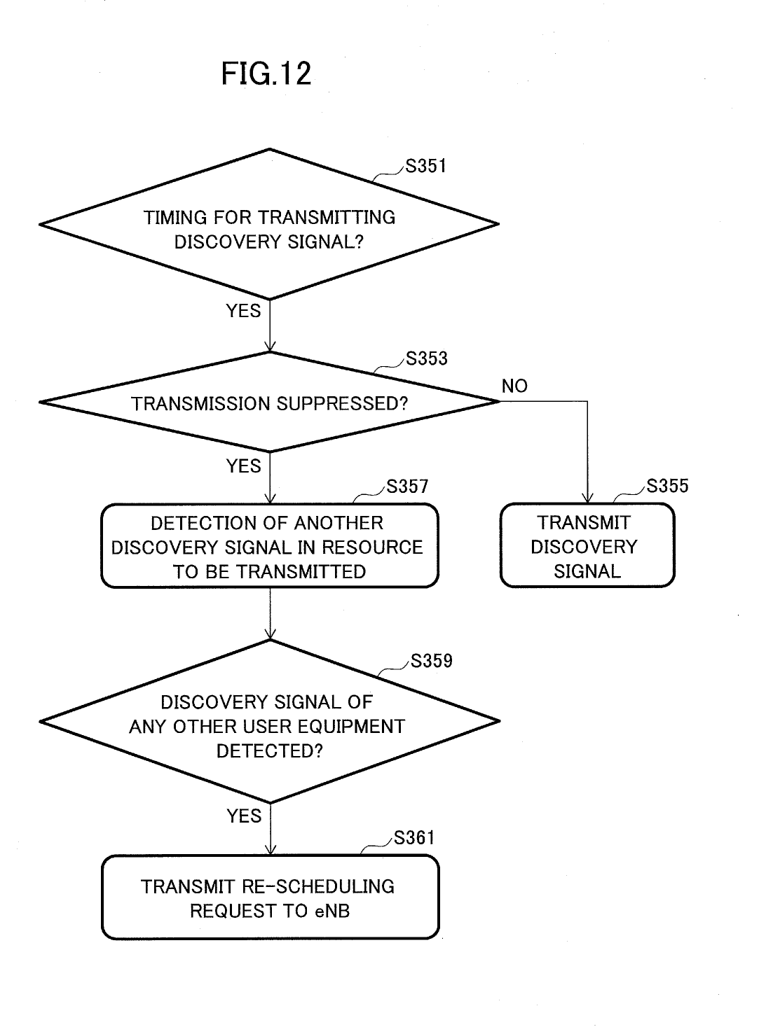

The detection of the collision of the discovery signals at steps S301 and S303 of FIG. 11 is further described by referring to FIG. 12. FIG. 12 is a flowchart illustrating the method of reporting the collision of the discovery signals in the user equipment according to the third example of the present invention.

When the timing comes to transmit a discovery signal (step S351), the transmission suppression unit 251 of the user equipment 250 determines whether the transmission of the discovery signal is to be muted (step S353). In a case where transmission of the discovery signal is not to be muted, the transmission suppression unit 251 causes the discovery signal transmitter 253 to transmit the discovery signal (step S355). In a case where transmission of the discovery signal is to be muted, the transmission suppression unit 251 causes the discovery signal receiver 255 to attempt to receive a discovery signal from any other user equipment (step S357). When the discovery signal receiver 255 receives a discovery signal from any other user equipment (step S359), the re-scheduling request unit 259 transmits a re-scheduling request to the base station (step S361).

In this manner, collision of discovery signals can be avoided by re-allocating, by the base station, a resource for the discovery signal based on the result of the collision reported from the user equipment.

Muting of transmission of a discovery signal by the transmission suppression unit 251 is further described.

The transmission suppression unit 251 may mute transmission of a discovery signal at a resource which is randomly selected. For example, the transmission suppression unit 251 may mute, for each timing to transmit a discovery signal, transmission with a constant probability p. Here, the probability p may be set in advance; and the probability p may be signaled from the base station. Further, for example, the transmission suppression unit 251 may mute transmission of a discovery signal once per K transmission timings. The value of K may be set in advance; and the value of K may be signaled from the base station. Here, it may be randomly selected, as to which timing of the K transmission timings, transmission is to be muted so as to avoid the user equipment UE A and UE B, for which the collision has occurred, from muting transmission of discovery signal at the same timing.

Further, the transmission suppression unit 251 may mute transmission of a discovery signal at a resource that differs depending on cells. For example, the transmission suppression unit 251 may mute transmission of a discovery signal at a resource that is obtained by a cell identifier (cell ID).

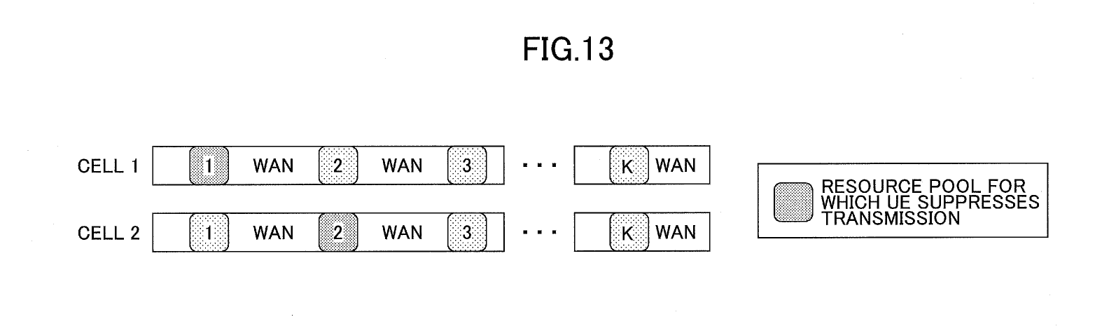

More specifically, the transmission suppression unit 251 may mute transmission in a discovery period n, which satisfies (cell ID) % K=n, by using the value K and the cell ID reported from the base station. FIG. 13 illustrates resources obtained based on the formula, at which transmission is to be muted. In the cell 1 that satisfies the cell ID=1, transmission is muted in the first discovery period; and in the cell 2 that satisfies the cell ID=2, transmission is muted in the second discovery period. In this manner, for each cell, the discovery period can be shifted, in which transmission is to be muted.

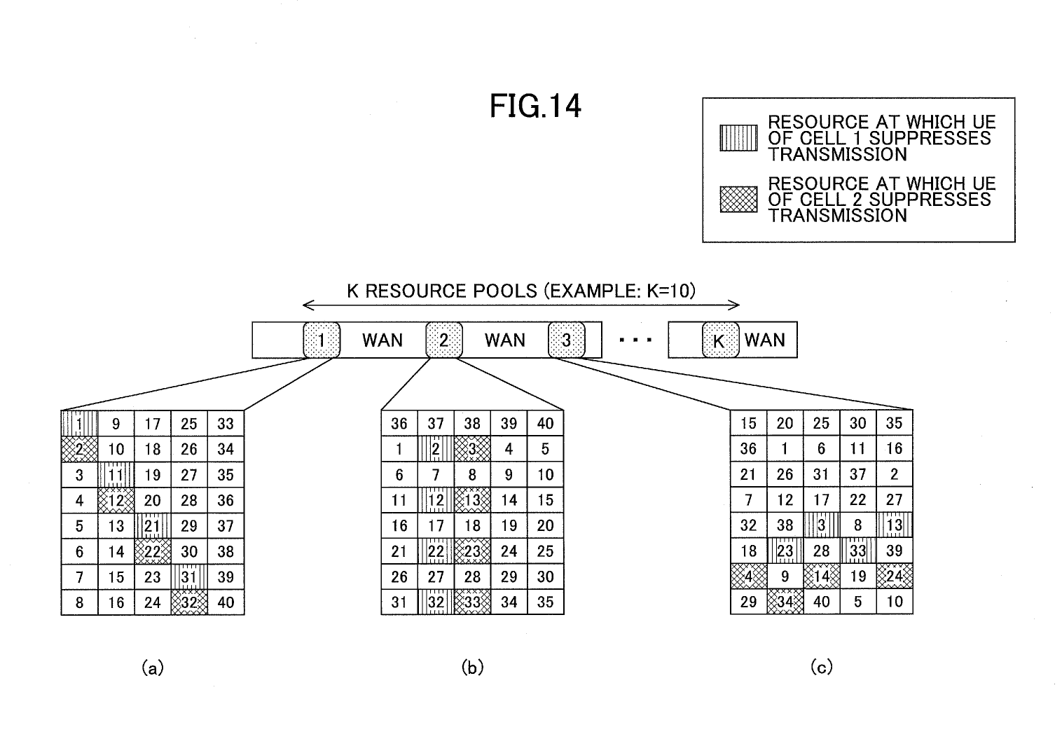

Furthermore, the transmission suppression unit 251 may mute transmission in a discovery period n, which satisfies (cell ID) % K=(n+Nr−1) % K, by using the value K and the cell ID reported from the base station. Here, Nr is a resource number within a resource pool allocated to the user equipment. FIG. 14 illustrates resources obtained based on the formula, at which transmission is to be muted. In a case where K=10, the user equipment of the cell 1 mutes transmission of a discovery signal in the first discovery period, if a resource number in the resource pool corresponds to 1, 11, 21, or 31. Furthermore, the user equipment of the cell 2 mutes transmission of a discovery signal in the first discovery period, if a resource number in the resource pool corresponds to 2, 12, 22, or 32. For the subsequent discovery period, the resources for which transmission of a discovery signal is to be muted can be obtained similarly. In this manner, for each cell, resources can be shifted, for which transmission is to be muted.

### Modified Example

In examples 1-3 of the present invention, the examples are described where the base station re-allocates, based on the result of the collision reported from the user equipment, or periodically, a resource for the discovery signal. As a modified example of these, an example is described where collision of discovery signals is avoided from the beginning.

Specifically, a base station may schedule a resource for a discovery signal based on a measurement result from user equipment. For example, specific user equipment may measure received energy of a resource, and report the measurement result to a base station, so that the base station may schedule a resource with which collision can be avoided. Furthermore, a base station may cause specific user equipment to measure received energy of a resource, and to report the measurement result, so that the base station may schedule a resource with which collision can be avoided.

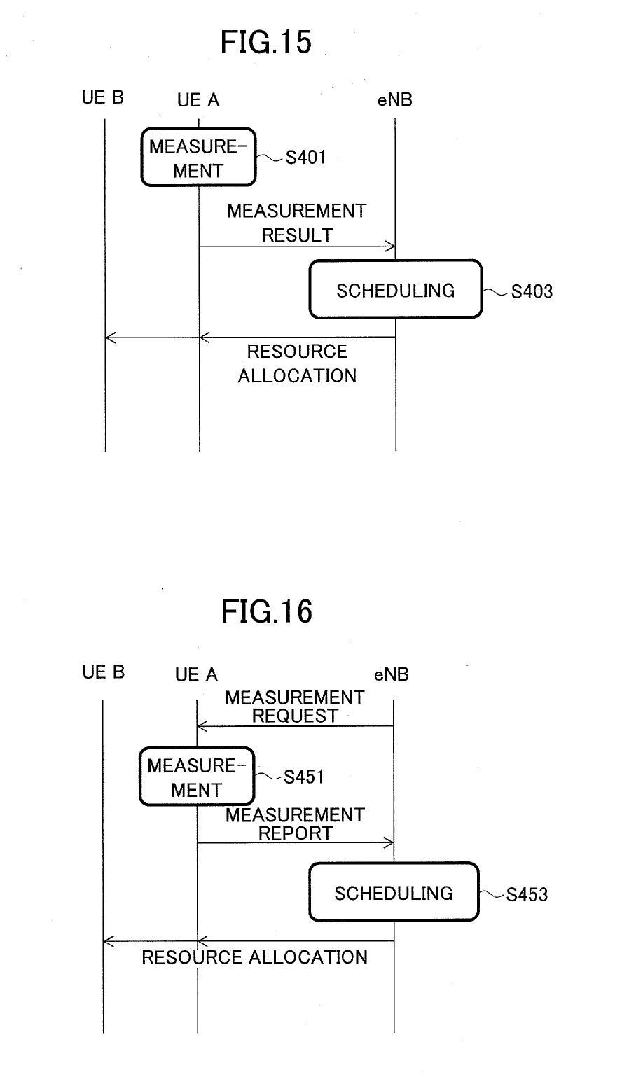

FIG. 15 is a sequence diagram illustrating a method of avoiding collision of discovery signals in user equipment and a base station according to the modified example of the present invention. FIG. 15 illustrates an example where specific user equipment measures received energy of a resource, and reports the measurement result to the base station, so that the base station schedules a resource with which collision can be avoided.

This modified example is described by using the base station 100 illustrated in FIG. 4 and the user equipment 200 illustrated in FIG. 6.

The discovery signal receiver 201 of the user equipment 200 measures received energy of a resource within a resource pool for transmitting a discovery signal (step S401). The reporting unit 205 transmits the measurement result of the received energy to the base station. The measurement result may include received energy of respective resources; and the measurement result may include positions of N time-frequency resources with low received energy, and/or positions of M time-frequency resources with high received energy. The measurement result may be reported through uplink RRC signaling; a physical uplink control channel (PUCCH); a physical uplink shared channel (PUSCH), and so forth. The RRC signaling, the PUCCH, and the PUSCH may be those of defined for the existing communication system, or may be those newly designed.

The receiver 101 of the base station 100 receives the measurement result from the user equipment. When a scheduling request is received from the user equipment, the scheduler 103 of the base station 100 allocates, to the user equipment, a resource for transmitting a discovery signal based on the measurement result (step S403). Note that the user equipment to which the resource is to be allocated may be the user equipment UE A, which is the same user equipment that has reported the measurement result; or may be the different user equipment UE B. The scheduler 103 may allocate a resource to the user equipment while avoiding a resource with received energy that is greater than a threshold value; or the scheduler 103 may allocate, to the user equipment, a resource with received energy that is less than the threshold value. The resource reporting unit 105 reports the allocated resource to the user equipment.

The user equipment starts transmitting a discovery signal with the resource allocated by the base station. Note that hopping on the resources is performed for each discovery period.

FIG. 16 is a sequence diagram illustrating a method of avoiding collision of discovery signals in user equipment and a base station according to a modified example of the present invention. FIG. 16 illustrates an example where the base station causes specific user equipment to measure received energy of a resource, and to repot the measurement result, so that the base station schedules a resource with which collision can be avoided.

The base station 100 transmits a measurement request for causing the user equipment to measure received energy of a resource within a resource pool for transmitting a discovery signal. For example, in order to attempt to distribute a load on the measurement by the user equipment, the base station may cause the user equipment to measure received energy of a part of resources formed by dividing the resource pool. This measurement request may be transmitted through downlink RRC signaling, a physical downlink control channel (PDCCH: Physical Downlink Control Channel or a ePDCCH: enhanced Physical Downlink Control Channel), a physical downlink shared channel (PDSCH: Physical Downlink Shared Channel), and so forth. The RRC signaling, the PDCCH or the ePDCCH, and the PDSCH may be those of defined for the existing communication system, or may be those newly designed.

The discovery signal receiver 201 of the user equipment 200 measures received energy of respective resources within the resource pool for transmitting the discovery signal (step S451). The reporting unit 205 transmits a measurement result of the received energy to the base station. The measurement result may include received energy of respective resources; and the measurement result may include positions of N time-frequency resources with low received energy, and/or positions of M time-frequency resources with high received energy. The measurement result may be reported through uplink RRC signaling; a physical uplink control channel (PUCCH); a physical uplink shared channel (PUSCH), and so forth. The RRC signaling, the PUCCH, and the PUSCH may be those of defined for the existing communication system, or may be those newly designed.

The receiver 101 of the base station receives the measurement result from the user equipment. Upon receiving a scheduling request from the user equipment, the scheduler 103 of the base station 100 allocates, to the user equipment, a resource for transmitting a discovery signal based on the measurement result (step S453). Note that the user equipment to which the resource is to be allocated may be the user equipment UE A, which is the same user equipment that has reported the measurement result; or may be the different user equipment UE B. The scheduler 103 may allocate a resource to the user equipment while avoiding a resource with received energy that is greater than a threshold value; or the scheduler 103 may allocate, to the user equipment, a resource with received energy that is less than the threshold value. The resource reporting unit 105 reports the allocated resource to the user equipment.

The user equipment starts transmitting a discovery signal with the resource allocated by the base station. Note that hopping on the resources is performed for each discovery period.

In this manner, by allocating, by the base station, a resource for a discovery signal based on the measurement result reported from the user equipment, collision of discovery signals can be avoided from the beginning.

### Fourth Example

In the fourth example of the present invention, an example is described where a resource pool for transmitting (and receiving) a discovery signal is divided into resource groups (or subsets) formed of a plurality of resources, and a base station schedules, in a specific resource group, a resource for the discovery signal, so as to avoid collision of discovery signals.

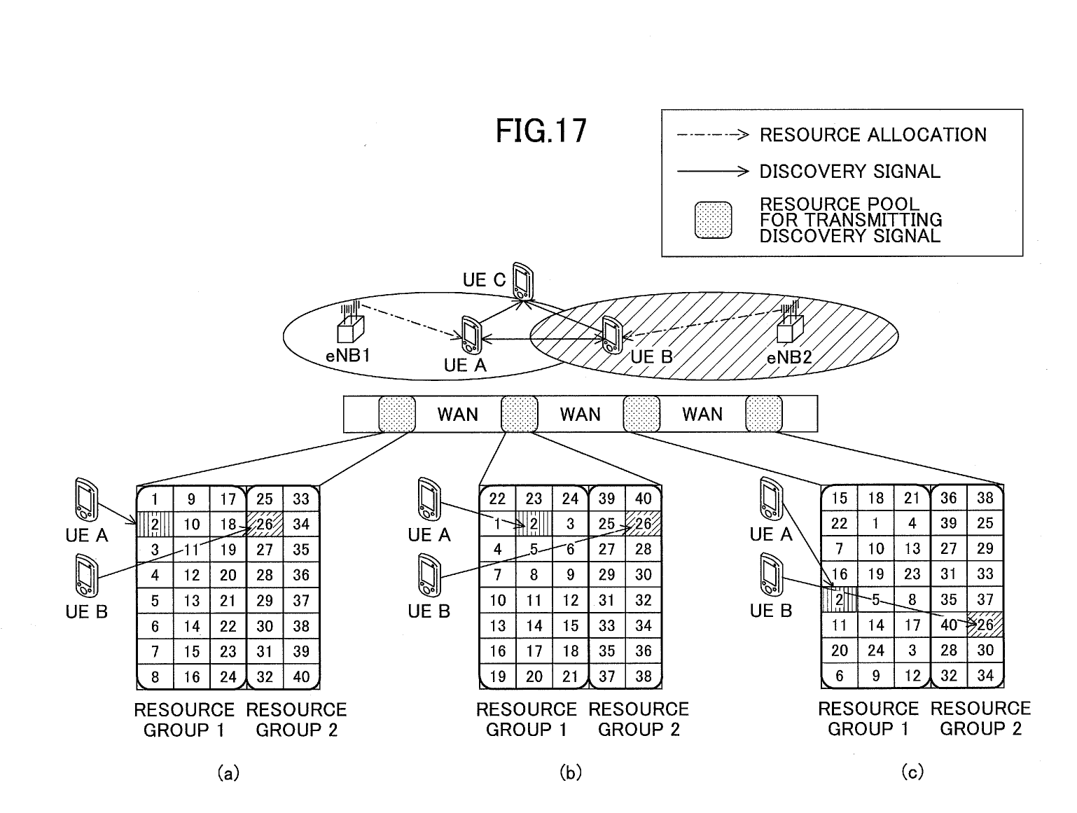

FIG. 17 is a schematic diagram illustrating a method of avoiding collision of discovery signals according to the fourth example of the present invention. As illustrated in FIG. 17, in the fourth example of the present invention, the resource pool for transmitting a discovery signal is divided into a plurality of resource groups (or subsets). In FIG. 17, an example is illustrated where the two base stations eNB 1 and eNB 2 are focused on, and the resource pool is divided into two resource groups 1 and 2. The resource pool can be divided into any number of resource groups.

The base station eNB 1 allocates, within the resource group 1, a resource to the user equipment UE A; and the base station eNB 2 allocates, within the resource group 2, a resource to the user equipment UE B. In this manner, the collision of the discovery signals can be avoided. Note that, for a case where hopping on resources is to be performed, it is limited to within a specific resource group.

The base station according to fourth example of the present invention is configured to be the same as that of FIG. 4.

The scheduler 103 allocates, within a predetermined resource group, a resource to the user equipment. As illustrated in FIG. 17, the resource groups to be used by respective base stations may be orthogonal on a frequency axis, or may be orthogonal on a time axis.

The resource reporting unit 105 reports the allocated resource to the user equipment.

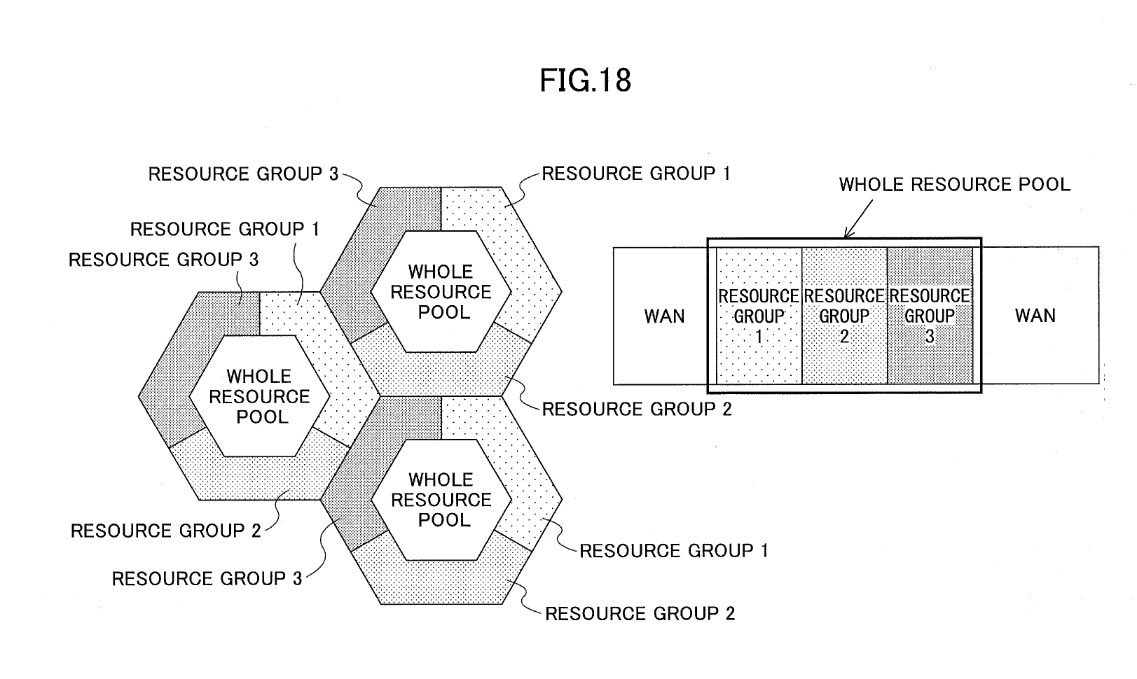

Here, in order to enhance resource utilization efficiency, the scheduler 103 may allocate, within the whole resource pool, a resource to user equipment at the center of the cell; and may allocate, within a resource group, a resource to user equipment at a cell edge, as illustrated in FIG. 18. The user equipment at the center of the cell may be, for example, user equipment with a path loss that is less than a threshold value; and the user equipment at the cell edge may be, for example, user equipment with a path loss that is greater than the threshold value. In this case, when hopping on resources is to be performed, it is also limited to within a specific resource group.

For a case where the user equipment to which the resource for transmitting the discovery signal has been allocated moves from the center of the cell to the cell edge, the scheduler 103 is required to re-allocate a resource.

Since it can be considered that inter-cell interference of the discovery signals is low for the user equipment at the center of the cell, by using the resource groups, such as those of illustrated in FIG. 18, the resource utilization efficiency can be enhanced, while reducing interference of the discovery signals.

### Effect of the Embodiment of the Present Invention

According to the embodiment of the present invention, for a case where user equipment transmits, in the D2D communication, a discovery signal with a resource that is allocated by a base station, collision of discovery signals between cells can be reduced or avoided.

According to the first example of the present invention, by the scheduling by the base station, collision of discovery signals between cells can be reduced with the simple method. However, the collision of the discovery signals may not be completely eliminated. Further, as the frequency of scheduling increases, collision of discovery signals can be reduced; however, the signaling cost increases.

According to the second example of the present invention, the base station can find collision of discovery signals; and, as a consequence, the collision of the discovery signals can be avoided by re-allocating a resource to the user equipment, for which it is required. Consequently, the signaling cost can be reduced, compared to the first example.

According to the third example of the present invention, the base station can find collision of discovery signals; and, as a result, collision of the discovery signals can be avoided by re-allocating a resource to the user equipment, for which it is required. Since only the user equipment that has detected the collision of the discovery signals transmits a re-scheduling request, the signaling cost can further be reduced, compared to the second example. However, by muting transmission, time spent for discovering the user equipment by the other user equipment may become longer. Additionally, the time until avoiding the collision may become longer, compared to the second example.

According to the fourth example of the present invention, by dividing the resource pool, collision of discovery signals can be avoided with a simple method. However, as a result of dividing the resource pool, the resource utilization efficiency is lowered. Furthermore, network planning is required, which is for properly allocating resource groups to base stations, respectively.

For the convenience of description, the base station and the user equipment according to the embodiment of the present invention are described by using the functional block diagrams; however, the base station and the user equipment according to the embodiment of the present invention may be implemented in hardware, software, or combinations thereof. Further, depending on necessity, the functional units may be combined and used. Furthermore, the methods according to the embodiment of the present invention may be implemented in an order which is different from the order illustrated in the embodiment.

The methods of reducing or avoiding collision of discovery signals between cells are described above; however, the present invention is not limited to the above-described embodiment, and various modifications and applications can be made within the scope of the claims.

This patent application is based upon and claims the benefit of priority of Japanese Patent Application No. 2014-097195 filed on May 8, 2014, the entire content of which is incorporated herein by reference.

### LIST OF REFERENCE SYMBOLS

100: base station
101: receiver
103: scheduler
105: resource reporting unit
200: user equipment
201: discovery signal receiver
203: collision detector
205: reporting unit
250: user equipment
251: transmission suppression unit
253: discovery
255: discovery signal receiver
257: collision detector
259: re-scheduling request unit

1. User equipment for receiving a discovery signal to be used for inter-user equipment discovery, the user equipment comprising:
a discovery signal receiver that receives the discovery signal transmitted, within a resource pool for transmitting the discovery signal, from any other user equipment;
a collision detector that detects collision of discovery signals; and
a reporting unit that reports a detected result of the collision to a base station.

2. The user equipment according to claim 1, wherein, when reception of the discovery signal fails for a specific resource, and when received energy at the specific resource is greater than a threshold value, the collision detector detects occurrence of the collision of the discovery signals.

3. The user equipment according to claim 1, further comprising:
a transmission suppression unit that mutes transmission of the discovery signal at a part of a resource allocated by the base station,
wherein, when a discovery signal from any other user equipment is received at the resource for which the transmission of the discovery signal is muted, the collision detector detects that there is a possibility that the collision of the discovery signals occurs.

4. The user equipment according to claim 3, wherein the transmission suppression unit mutes the transmission of the discovery signal at a randomly selected resource or a resource that is obtained based on a cell identifier.

5. A collision reporting method for use in user equipment for receiving a discovery signal to be used for inter-user equipment discovery, the collision reporting method comprising:
a step of receiving the discovery signal transmitted, within a resource pool for transmitting the discovery signal, from any other user equipment;
a step of detecting collision of discovery signals; and
a step of reporting a detected result of the collision to a base station.

6. A base station for allocating, to user equipment, a resource for a discovery signal to be used for inter-user equipment discovery, the base station comprising:
a scheduler that allocates, within a resource pool for transmitting the discovery signal, the resource for the discovery signal to the user equipment; and
a resource reporting unit that reports the allocated resource to the user equipment,
wherein the scheduler re-allocates, based on a result of collision reported from the user equipment, or periodically, a resource for the discovery signal.

7. The base station according to claim 6, further comprising:
a receiver that receives the result of the collision of discovery signals, the result of the collision being reported from the user equipment,
wherein the scheduler re-allocates, based on the reported result of the collision of the discovery signals, a resource for the discovery signal of the user equipment for which the collision occurs, or the user equipment for which there is a possibility that the collision occurs.

8. A resource allocation method for use in a base station for allocating, to user equipment, a resource for a discovery signal to be used for inter-user equipment discovery, the resource allocation method comprising:
a step of allocating, within a resource pool for transmitting the discovery signal, the resource for the discovery signal to the user equipment;
a step of reporting the allocated resource to the user equipment; and
a step of re-allocating, based on a result of collision reported from the user equipment, or periodically, a resource for the discovery signal.

9. A base station for allocating, to user equipment, a resource for a discovery signal to be used for inter-user equipment discovery, the base station comprising:
a scheduler that allocates, within a predetermined resource group of resource groups formed by dividing a resource pool for transmitting the discovery signal, the resource for the discovery signal to the user equipment; and
a resource reporting unit that reports the allocated resource to the user equipment.

10. A resource allocation method for use in a base station for allocating, to user equipment, a resource for a discovery signal to be used for inter-user equipment discovery, the resource allocation method comprising:
a step of allocating, within a predetermined resource group of resource groups formed by dividing a resource pool for transmitting the discovery signal, the resource for the discovery signal to the user equipment; and
a step of reporting the allocated resource to the user equipment.
